(19) United States
(12) Patent Application Publication
(10) Pub. No.: US 2017/0349740 A1
(43) Pub. Date: Dec. 7, 2017

(54) THERMOPLASTIC RESIN COMPOSITION

(71) Applicants: Denka Company Limited, Chuo-ku, Tokyo (JP); National University Corporation Yamagata UniversitY, Yamagata-shi, Yamagata (JP)

(72) Inventors: Kohhei Nishino, Ichihara-city (JP); Yuichi Shindo, Ichihara-city (JP); Yoshinari Kurokawa, Ichihara-city (JP); Tetsuo Takayama, Yonezawa-shi (JP); Kyohei Ikeda, Yonezawa-shi (JP)

(73) Assignees: Denka Company Limited, Chuo-ku, Tokyo (JP); National University Corporation Yamagata University, Yamagata-shi, Yamagata (JP)

(21) Appl. No.: 15/537,795

(22) PCT Filed: Dec. 18, 2015
(86) PCT No.: PCT/JP2015/085502

§ 371 Date: Aug. 16, 2017

(30) Foreign Application Priority Data
Dec. 19, 2014 (JP) 2014-257584

(51) Int. Cl. C08L 25/12; C08L 55/02; C08L 51/04; C08L 69/00; C08L 35/00

(52) U.S. Cl. CPC C08L 25/12; C08L 69/00; C08L 35/00; C08L 51/04; C08L 55/02

(57) ABSTRACT

Provided are a polycarbonate/ABS-based thermoplastic resin composition excellent in hydrolysis resistance and impact resistance and a molded article thereof. A thermoplastic resin composition includes: polycarbonate (A); a graft copolymer (B) produced by graft copolymerization of a rubbery polymer at least with a styrene-based monomer and an acrylonitrile-based monomer and containing a metal element; a styrene-acrylonitrile based copolymer (C); and an unsaturated dicarboxylic anhydride-based copolymer (D), wherein a content of (D) is 2 to 25 mass %.

### TECHNICAL FIELD

The present invention relates to a thermoplastic resin composition and a molded article thereof.

### BACKGROUND ART

Resin compositions of polycarbonate and an ABS resin (hereinafter, referred to as “a PC/ABS-based resin”) are excellent in impact resistance, heat resistance, and molding processability, and they are thus applied to various uses including automobile parts, home appliances, and business machine parts. Polycarbonate is easily hydrolyzed, and inorganic salt as impurities in an ABS resin may hydrolyze polycarbonate, sometimes causing reduction in properties, such as impact strength of a PC/ABS-based resin. The techniques below improve hydrolysis in PC/ABS-based resins, where an ABS-based resin is used that contains less or no inorganic salt.

### CITATION LIST

### Patent Literature

PTL 1: JP 6-263962A
PTL 2: JP 2001-226576A
PTL 3: JP 2008-525582A

### SUMMARY OF THE INVENTION

### Technical Problem

It is an object of the present invention to provide a new PC/ABS-based thermoplastic resin composition and a molded article thereof.

### Solution to Problem

That is, the present invention is as follows.

1) A thermoplastic resin composition including: polycarbonate (A); a graft copolymer (B) produced by graft copolymerization of a rubbery polymer at least with a styrene-based monomer and an acrylonitrile-based monomer and containing a metal element; a styrene-acrylonitrile based copolymer (C); and an unsaturated dicarboxylic anhydride-based copolymer (D), wherein, based on 100 mass % of a total amount of (A) to (D), a content of (A) is 40 to 93 mass %, a content of (B) is 5 to 30 mass %, a content of (C) is 0 to 40 mass %, and a content of (D) is 2 to 25 mass %.

2) The composition according to 1), wherein the unsaturated dicarboxylic anhydride-based copolymer (D) has unsaturated dicarboxylic anhydride-based monomer units of 0.5 to 30 mass %.

3) A molded article, comprising the composition according to 1) or 2).

### Advantageous Effects of Invention

The thermoplastic resin composition of the present invention is useful for automobile parts, home appliances, business machine parts, and the like that require hydrolysis resistance and impact resistance.

### DESCRIPTION OF EMBODIMENTS

### Definition

A description of “A-B”, for example, herein means a range between A or more and B or less.

Detailed descriptions are given below to embodiments of the present invention.

A thermoplastic resin composition of the present invention includes: polycarbonate (A); a graft copolymer (B) produced by graft copolymerization of a rubbery polymer at least with a styrene-based monomer and an acrylonitrile-based monomer and containing a metal element; a styrene-acrylonitrile based copolymer (C); and an unsaturated dicarboxylic anhydride-based copolymer (D). Based on 100 mass % of a total amount of (A) to (D), a content of (A) is 40-93 mass %, a content of (B) is 5-30 mass %, a content of (C) is 0-40 mass %, and a content of (D) is 2-25 mass %. Preferably, the content of (A) is 45-80 mass %, the content of (B) is 10-20 mass %, the content of (C) is 5-30 mass %, and the content of (D) is 4-20 mass %. In particular, the content of (D) is more preferably 5.0-15 mass % and even more preferably 7.0-13 mass %. A too small content of (D) may cause insufficient hydrolysis resistance. A too large content of (D) may cause reduction in impact resistance.

Polycarbonate (A) is a polymer having a carbonate bond represented by a general formula —[—O—R—O—C(═O)—]—. R is generally hydrocarbon. Depending on the type of material dihydroxy compound, examples of R include aromatic polycarbonate, aliphatic polycarbonate, and alicyclic polycarbonate. Polycarbonate (A) may be a homopolymer of a single type of constitutional repeating unit or may be a copolymer of two or more types of constitutional repeating units. Polycarbonate made from bisphenol A as a material for such a dihydroxy compound is widely produced for industrial applications and is suitably used herein.

For a method of producing polycarbonate (A), a known technique may be employed. Examples of the method include ester interchange (also called as a melting method or a melt polymerization method) where bisphenol A and diphenyl carbonate are melted at high temperatures for transesterification during removal of phenol produced under a reduced pressure, a phosgene method (also called as an interfacial polymerization method) where phosgene acts on an aqueous caustic soda solution or an aqueous suspension of bisphenol A in the presence of methylene chloride for synthesis, a pyridine method where phosgene is reacted with bisphenol A in the presence of pyridine and methylene chloride for synthesis, and the like.

Polycarbonate (A) preferably has a weight average molecular weight 10,000-200,000 and more preferably 10,000-100,000. The weight average molecular weight of polycarbonate (A) is a polystyrene equivalent measured by gel permeation chromatography (GPC).

The graft copolymer (B) is produced by graft copolymerization of a rubbery polymer at least with a styrene-based monomer and an acrylonitrile-based monomer and includes, for example, an acrylonitrile-butadiene-styrene copolymer (ABS resin).

The rubbery polymer in the graft copolymer (B) is a polymer exhibiting rubbery elasticity at a glass transition temperature of 0° C. Examples of the polymer include the followings: conjugated diene-based rubber, such as polybutadiene, styrene-butadiene copolymers, styrene-butadiene-styrene copolymers, polyisoprene, and styrene-isoprene copolymers, and hydrogenation products thereof; acrylic rubber of butyl acrylate, ethyl acrylate, and the like; ethylene-α-olefin copolymers; and the like.

A rubbery polymer content in the graft copolymer (B) is, from the perspective of impact resistance, preferably 40-70 mass % and more preferably 45-65 mass %. The rubbery polymer content may be regulated by, for example, ratios of the styrene-based monomer and the acrylonitrile-based monomer relative to the rubbery polymer in emulsion graft polymerization.

The styrene-based monomer includes styrene, o-methylstyrene, m-methylstyrene, p-methylstyrene, 2,4-dimethylstyrene, ethylstyrene, p-t-butylstyrene, α-methylstyrene, α-methyl-p-methylstyrene, and the like. Among them, styrene is preferred. The styrene-based monomer may be composed of one or more types.

The acrylonitrile-based monomer includes acrylonitrile, methacrylonitrile, ethacrylonitrile, fumaronitrile, and the like. Among them, acrylonitrile is preferred. The acrylonitrile-based monomer may be composed of one or more types.

Other graft copolymerizable monomers may be used, including: (meth)acrylate-based monomers, such as methyl methacrylate; acrylate-based monomers, such as butyl acrylate and ethyl acrylate; (meth)acrylic acid-based monomers, such as methacrylic acid; acrylic acid-based monomers, such as acrylic acid; and N-substituted maleimide-based monomers, such as N-phenylmaleimide.

From the perspective of impact resistance of the PC/ABS-based resin, the graft copolymer (B) constituents other than the rubbery polymer are preferably styrene-based monomer units of 70-85 mass % and acrylonitrile-based monomer units of 15-30 mass %.

The graft copolymer (B) may be produced by a known technique. In an example of such a method, latex as a rubbery polymer produced by emulsion polymerization is subjected to emulsion graft copolymerization with a styrene-based monomer and an acrylonitrile-based monomer (hereinafter, referred to as “emulsion graft polymerization”). By emulsion graft polymerization, latex of the graft copolymer (B) is produced. Such emulsion graft polymerization sometimes by-produces a copolymer of a styrene-based monomer and an acrylonitrile-based monomer that are not grafted to the rubbery polymer to be contained in the graft copolymer. The graft copolymer (B) is preferably produced by emulsion graft polymerization due to the capability of increasing the rubbery polymer content and the high effect of improving impact resistance of the PC/ABS-based resin.

In emulsion polymerization and emulsion graft polymerization, water, an emulsifier, a polymerization initiator, and a chain transfer agent are used and the polymerization temperature preferably ranges 30-90° C. Examples of the emulsifier include anionic surfactants, cationic surfactants, amphoteric surfactants, and the like. Examples of the polymerization initiator include the followings: organic peroxides, such as cumene hydroperoxide, diisopropyl enzene peroxide, t-butyl peroxyacetate, t-hexyl peroxybenzoate, and t-butyl peroxybenzoate; persulfates, such as potassium persulfate and ammonium persulfate; azo compounds, such as azobisbutyronitrile; reducing agents, such as iron ions; secondary reducing agents, such as sodium formaldehyde sulfoxylate; chelating agents, such as disodium ethylenediaminetetraacetate; and the like. Examples of the chain transfer agent include n-octyl mercaptan, n-dodecyl mercaptan, t-dodecyl mercaptan, α-methylstyrene dimers, ethyl thioglycolate, limonene, terpinolene, and the like.

Latex of the graft copolymer (B) may be coagulated by a known method for recovery of the graft copolymer (B). For example, a coagulant is added to latex of the graft copolymer (B) for coagulation, and the is washed and dewatered by dewatering equipment and then subjected to a drying process to produce powdered graft copolymer (B). The wet powder before drying may be directly put into a vented extruder to allow pelletization. The coagulant is inorganic salt, and acid may be used in combination. Examples of such inorganic salt (more specifically, inorganic metal salt) include the followings: sulfates, such as magnesium sulfate, sodium sulfate, and aluminum sulfate; chlorides, such as calcium chloride, magnesium chloride, and sodium chloride; and acetates, such as calcium acetate. Any of the examples contains a metal element. The inorganic salt may be composed of a single type or more types in combination.

During the coagulation process of the graft copolymer (B), an emulsifier may react with a coagulant to produce organic salt. For example, fatty acid magnesium is produced using fatty acid potassium as the emulsifier and magnesium sulfate as the coagulant.

The inorganic or organic salt used as a coagulant remains even after washing and dewatering, and the graft copolymer (B) thus contains inorganic or organic salt derived from the coagulant. Since the inorganic or organic salt used as a coagulant accelerates hydrolysis of polycarbonate, a graft copolymer with a small inorganic or organic salt content is produced by a coagulating method using only inorganic acid as a coagulant or a coagulating method using both inorganic acid and inorganic salt and in a low pH condition at a pH of 3 or less. These methods, however, have a problem of production process corrosion due to inorganic acid. In the present invention, to prevent the production process corrosion, pH for coagulation is preferably 6.0-7.5 and more preferably 6.5-7.0. The inorganic salt content in the graft copolymer (B) is confirmed by atomic absorption in terms of metal elements. In the case of using, for example, magnesium sulfate as a coagulant, the magnesium content in the graft copolymer (B) is 300 ppm or more. The metal element content in the graft copolymer (B) is preferably 100-1500 ppm and even more preferably 200-1200 ppm, 300-1000 ppm, and 400-800 ppm. Inorganic or organic salt may be appropriately added to the graft copolymer (B) coagulated in a low pH condition and with a small metal element content to regulate the metal element content.

The graft copolymer (B) preferably has a particulate gel content. The gel content is rubbery polymer particles produced by graft copolymerization of the styrene-based monomer with the acrylonitrile-based monomer. The gel content is also a component insoluble in an organic solvent, such as methyl ethyl ketone and toluene, and centrifugally separated. Inside the rubbery polymer particles, an occlusion structure may be formed that includes a particulate styrene-acrylonitrile based copolymer. When the graft copolymer (B) and the styrene-acrylonitrile based copolymer (C) are melt blended, the gel content is in a particulate dispersed phase within a continuous phase of the styrene-acrylonitrile based copolymer. The gel content is a value calculated by Gel Content (mass %)=(S/W)×100, where a mass W of the graft copolymer (B) is dissolved in methyl ethylene ketone and centrifugally separated at 20000 rpm with a centrifugal separator to precipitate insoluble matter and then a supernatant is removed by decantation to produce the insoluble matter and obtain a mass S of the dried insoluble matter after vacuum drying. The gel content is also calculated by dissolving a resin composition produced by melt blending the graft copolymer (B) and the styrene-acrylonitrile based copolymer (C), in the same manner, in methyl ethyl ketone and centrifugally separating the solution.

The graft copolymer (B) has a gel content with a volume average particle size of, from the perspective of the impact resistance and the appearance of a molded article of the resin composition, preferably 0.10-1.0 μm and more preferably 0.15-0.50 μm. The volume average particle size is a value calculated as follows: an ultrathin section is sliced from pellets of the resin composition produced by melt blending the graft copolymer (B) and the styrene-acrylonitrile based copolymer (C); the slice is observed under a transmission electron microscope (TEM); and the image of the particles dispersed in the continuous phase is analyzed. The volume average particle size may be regulated by, for example, the latex particle size in the rubbery polymer used in emulsion graft polymerization. The latex particle size in the rubbery polymer may be regulated by a method of adding an emulsifier, an amount of water to be used, or the like in emulsion polymerization. This method, however, takes a time for polymerization and is low in productivity to regulate in a preferred range. There is another method including polymerizing a rubbery polymer with a particle size of approximately 0.1 μm for a short time and enlarging rubber particles using chemical coagulation and physical coagulation.

The graft copolymer (B) has a graft ratio of, from the perspective of impact resistance, preferably 10-100 mass % and more preferably 20-70 mass %. The graft ratio is a value calculated by Graft Ratio (mass %)=[(G−RC)/R]×100 from a gel content (G) and a rubbery polymer content (RC). The graft ratio indicates amounts of the styrene-acrylonitrile based copolymer bonded by graft and the styrene-acrylonitrile based copolymer included in the particles that are contained in the rubbery polymer particles per unit mass of the rubbery polymer. The graft ratio may be regulated, for example, in emulsion graft polymerization by the ratio of the monomer to the rubbery polymer, the type and the amount of the initiator, the amount of the chain transfer agent, the amount of the emulsifier, the polymerization temperature, the charging method (bulk/multi-stage/continuous), the rate of adding the monomer, and the like.

The graft copolymer (B) has a degree of swelling in toluene of, from the perspective of the impact resistance and the appearance of a molded article of the resin composition, preferably 5-20 times. The degree of swelling in toluene indicates a degree of crosslinking of the rubbery polymer particles. The degree of swelling in toluene is calculated as follows: dissolving the graft copolymer in toluene; separating insoluble matter by centrifugal separation or filtration; and a mass ratio is obtained from the state of being swelled with toluene and the state of being dried after removing toluene by vacuum drying. The degree of swelling in toluene is influenced by, for example, the degree of crosslinking of the rubbery polymer used in emulsion graft polymerization. The degree of swelling in toluene may be regulated by the initiator, the emulsifier, the polymerization temperature, addition of a multifunctional monomer, such as divinylbenzene, and the like during emulsion polymerization of the rubbery polymer.

The styrene-acrylonitrile based copolymer (C) is a copolymer having styrene-based monomer units and acrylonitrile-based monomer units, and examples of the copolymer (C) include a styrene-acrylonitrile copolymer.

Other copolymerizable monomers for the styrene-acrylonitrile based copolymer (C) may be used, including: (meth)acrylate-based monomers, such as methyl methacrylate; acrylate-based monomers, such as butyl acrylate and ethyl acrylate; (meth)acrylic acid-based monomers, such as methacrylic acid; acrylic acid-based monomers, such as acrylic acid; and N-substituted maleimide-based monomers, such as N-phenylmaleimide.

The constituents of the styrene-acrylonitrile based copolymer (C) are, from the perspective of compatibility with polycarbonate, preferably 70-85 mass % of styrene-based monomer units and 15-30 mass % of acrylonitrile-based monomer units. The acrylonitrile-based monomer units are measured by the Kjeldahl method.

The styrene-acrylonitrile based copolymer (C) may be produced by a known method. It may be produced by, for example, bulk polymerization, solution polymerization, suspension polymerization, emulsion polymerization, or the like. The reactor may be operated by any of the continuous method, the batch method, the semi-batch method. From the perspective of quality and productivity, bulk polymerization or solution polymerization is preferred and the continuous method is preferred. Examples of the solvent for bulk polymerization or solution polymerization include the followings: alkylbenzenes, such as benzene, toluene, ethylbenzene, and xylene; ketones, such as acetone and methyl ethyl ketone; aliphatic hydrocarbon, such as hexane and cyclohexane; and the like.

For bulk polymerization or solution polymerization of the styrene-acrylonitrile based copolymer (C), a polymerization initiator and a chain transfer agent may be used and the polymerization temperature preferably ranges 120-170° C. Examples of the polymerization initiator include the followings: peroxyketals, such as 1,1-di(t-butylperoxy)cyclohexane, 2,2-di(t-butylperoxy)butane, 2,2-di(4,4-di-t-butylperoxycyclohexyl)propane, and 1,1-di(t-amylperoxy)cyclohexane; hydroperoxides, such as cumene hydroperoxide and t-butyl hydroperoxide; alkyl peroxides, such as t-butyl peroxyacetate and t-amylperoxyisononanoate; dialkyl peroxides, such as t-butyl cumyl peroxide, di-t-butyl peroxide, dicumyl peroxide, and di-t-hexyl peroxide; peroxy esters, such as t-butyl peroxyacetate, t-butyl peroxybenzoate, and t-butylperoxyisopropyl monocarbonate; peroxy carbonates, such as t-butylperoxyisopropyl carbonate and polyether tetrakis(t-butyl peroxycarbonate); N,N′-azobis(cyclohexane-1-carbonitrile); N,N′-azobis(2-methylbutyronitrile); N,N′-azobis(2,4-dimethylvaleronitrile); N,N′-azobis[2-(hydroxymethyl)propionitrile]; and the like. A single type or more types of them in combination may be used. Examples of the chain transfer agent include n-octyl mercaptan, n-dodecyl mercaptan, t-dodecyl mercaptan, α-methylstyrene dimers, ethyl thioglycolate, limonene, terpinolene, and the like.

A devolatilization method may be a known technique to remove the volatile components, such as the unreacted monomer, and the solvent used for solution polymerization from the solution after finishing polymerization of the styrene-acrylonitrile based copolymer (C). For example, a vacuum devolatilization chamber with a preheater or a vented devolatilization extruder may be used. The devolatilized and molten styrene-acrylonitrile based copolymer (C) may be transferred to a granulation process and extruded in a strand from a porous die to be processed into pellets by cold cutting, hot cutting with air steam, or hot cutting under water.

The styrene-acrylonitrile based copolymer (C) has a weight average molecular weight of, from the perspective of impact resistance and moldability of the PC/ABS-based resin, preferably 50,000-250,000 and more preferably 70,000-200,000. The weight average molecular weight of the styrene-acrylonitrile based copolymer (C) is a polystyrene equivalent measured in a THF solvent by gel permeation chromatography (GPC). The weight average molecular weight may be regulated in polymerization by the type and the amount of the chain transfer agent, the solvent concentration, the polymerization temperature, and the type and the amount of the polymerization initiator.

The unsaturated dicarboxylic anhydride-based copolymer (D) is a copolymer having unsaturated dicarboxylic anhydride-based monomer units and styrene-based monomer units. In the present invention, this copolymer may further have maleimide-based monomer units, (meth)acrylate-based monomer units, and acrylonitrile-based monomer units. Examples of the unsaturated dicarboxylic anhydride-based copolymer (D) include styrene-N-phenylmaleimide-maleic anhydride copolymers, styrene-methyl methacrylate-maleic anhydride copolymers, styrene-maleic anhydride copolymer, styrene-acrylonitrile-N-phenylmaleimide-maleic anhydride copolymer, and the like.

An unsaturated dicarboxylic anhydride-based monomer includes maleic anhydride, itaconic anhydride, citraconic anhydride, aconitic anhydride, and the like. Among them, maleic anhydride is preferred. The unsaturated dicarboxylic anhydride-based monomer may be composed of one or more types.

Examples of the maleimide-based monomer unit include structural units derived from the followings: N-alkylmaleimide, such as N-methylmaleimide, N-butylmaleimide, and N-cyclohexylmaleimide; N-arylmaleimide, such as N-phenylmaleimide, N-chlorphenylmaleimide, N-methylphenylmaleimide, N-methoxyphenylmaleimide, and N-tribromophenylmaleimide; and the like. Among them, N-cyclohexylmaleimide and N-phenylmaleimide are preferred. The maleimide-based monomer units may be composed of one or more types.

Examples of the (meth)acrylate-based monomer unit include the followings: methacrylate monomers, such as methyl methacrylate, ethyl methacrylate, n-butyl methacrylate, 2-ethylhexyl methacrylate, dicyclopentanyl methacrylate, and isobornyl methacrylate; and acrylate monomers, such as methyl acrylate, ethyl acrylate, n-butyl acrylate, 2-methylhexyl acrylate, 2-ethylhexyl acrylate, and decyl acrylate. Among them, methyl methacrylate units are preferred. The (meth)acrylate monomer may be composed of one or more types.

The constituents of the unsaturated dicarboxylic anhydride-based copolymer (D) are preferably 0.5-30 mass % of unsaturated dicarboxylic anhydride-based monomer units, 40-80 mass % of styrene-based monomer units, 0-60 mass % of maleimide-based monomer units, 0-30 mass % of (meth)acrylate-based monomer units, and 0-30 mass % of acrylonitrile-based monomer units. The unsaturated dicarboxylic anhydride-based monomer units are more preferably 5.0-30 mass %. The total amount of the unsaturated dicarboxylic anhydride-based monomer units and the maleimide-based monomer units is, from the perspective of compatibility with the styrene-acrylonitrile based copolymer (C), preferably 10-70 mass % and more preferably 20-60 mass %. Too few unsaturated dicarboxylic anhydride-based monomer units may cause reduction in hydrolysis resistance of the PC/ABS-based resin and too many units may cause reduction in thermal stability of the unsaturated dicarboxylic anhydride-based copolymer (D). The unsaturated dicarboxylic anhydride-based monomer units are measured by the titrimetric method. The styrene-based monomer units, the maleimide-based monomer units, and the (meth)acrylate-based monomer units are measured by NMR.

The unsaturated dicarboxylic anhydride-based copolymer (D) may be produced by a known method. An example of such a method is a method of copolymerizing a monomer mixture of an unsaturated dicarboxylic anhydride-based monomer, a styrene-based monomer, a maleimide-based monomer, a (meth)acrylate-based monomer, and an acrylonitrile-based monomer. Another example is a method including copolymerizing a monomer mixture of an unsaturated dicarboxylic anhydride-based monomer, a styrene-based monomer, a (meth)acrylate-based monomer, and an acrylonitrile-based monomer, followed by imidation by reacting part of the unsaturated dicarboxylic anhydride-based monomer units with ammonium or primary amine for conversion into maleimide-based monomer units (hereinafter, referred to as “a post-imidation method”).

The unsaturated dicarboxylic anhydride-based copolymer (D) may be produced by a known method. It may be produced by, for example, solution polymerization, bulk polymerization, and the like. Any of the continuous method and the batch method is applicable. Since copolymerization of a styrene-based monomer with an unsaturated dicarboxylic anhydride-based monomer or that of a styrene-based monomer with a maleimide-based monomer has high alternating copolymerizability, solution polymerization is preferred to homogenize the copolymerization composition by split adding the unsaturated dicarboxylic anhydride-based monomer or the maleimide-based monomer for polymerization. Examples of the solvent for solution polymerization include the followings: ketones, such as acetone, methyl ethyl ketone, methyl isobutyl ketone, and acetophenone; ethers, such as tetrahydrofuran and 1,4-dioxane; aromatic hydrocarbons, such as benzene, toluene, xylene, and chlorobenzene; N,N-dimethylformamide; dimethyl sulfoxide; N-methyl-2-pyrrolidone; and the like. For the ease of solvent removal in devolatilization recovery of the unsaturated dicarboxylic anhydride-based copolymer (D), methyl ethyl ketone or methyl isobutyl ketone is preferred.

For solution polymerization or bulk polymerization of the unsaturated dicarboxylic anhydride-based copolymer (D), a polymerization initiator and a chain transfer agent may be used and the polymerization temperature preferably ranges 70-150° C. Examples of the polymerization initiator include the followings: azo compounds, such as azobisisobutyronitrile, azobiscyclohexanecarbonitrile, azobismethylproponitrile, and azobismethylbutyronitrile; and peroxides, such as benzoyl peroxide, t-butyl peroxybenzoate, 1,1-di(t-butylperoxy)cyclohexane, t-butyl peroxyisopropyl monocarbonate, t-butylperoxy-2-ethylhexanoate, di-t-butylperoxide, dicumyl peroxide, and ethyl-3,3-di-(t-butylperoxy)butyrate. A single type or more types of them in combination may be used. Examples of the chain transfer agent include n-octyl mercaptan, n-dodecyl mercaptan, t-dodecyl mercaptan, α-methylstyrene dimers, ethyl thioglycolate, limonene, terpinolene, and the like.

The maleimide-based monomer units are introduced into the unsaturated dicarboxylic anhydride-based copolymer (D) by a method of copolymerizing a maleimide-based monomer or by the post-imidation method. The post-imidation method is a method including copolymerizing a monomer mixture of an unsaturated dicarboxylic anhydride-based monomer, a styrene-based monomer, a (meth)acrylate-based monomer, and an acrylonitrile-based monomer, followed by imidation by reacting part of the unsaturated dicarboxylic anhydride-based monomer units with ammonium or primary amine for conversion into maleimide-based monomer units. Examples of the primary amine include the followings: alkylamines, such as methylamine, ethylamine, n-propylamine, iso-propylamine, n-butylamine, n-pentylamine, n-hexylamine, n-octylamine, cyclohexylamine, and decylamine; and aromatic amines, such as chloro- or bromo-substituted alkylamine, aniline, toluidine, and naphtylamine. Among them, aniline or cyclohexylamine is preferred. These primary amines may be used singly or in combination of two or more types. For the post-imidation, in the reaction of the primary amine with the unsaturated dicarboxylic anhydride-based monomer units, a catalyst may be used to improve the dehydrative cyclization reaction. Examples of the catalyst include trimethylamine, triethylamine, tripropylamine, tributylamine, N,N-dimethylaniline, N,N-diethylaniline, and the like. The temperature for the post-imidation is preferably 100-250° C. and more preferably 120-200° C.

A method to remove the solvent used for solution polymerization and the volatile components, such as the unreacted monomer, from the solution after finishing solution polymerization of the unsaturated dicarboxylic anhydride-based copolymer (D) or the solution after finishing the post-imidation may be a known technique. For example, a vacuum devolatilization chamber with a heater or a vented devolatilization extruder may be used. The devolatilized and molten unsaturated dicarboxylic anhydride-based copolymer (D) may be transferred to a granulation process and extruded in a strand from a porous die to be processed into pellets by cold cut, air hot cut, or water hot cut.

The unsaturated dicarboxylic anhydride-based copolymer (D) has a weight average molecular weight of preferably 50,000-300,000 and more preferably 80,000-200,000. The unsaturated dicarboxylic anhydride-based copolymer (D) is a polystyrene equivalent measured in a THF solvent by gel permeation chromatography (GPC). The weight average molecular weight may be regulated in polymerization by the type and the amount of the chain transfer agent, the solvent concentration, the polymerization temperature, and the type and the amount of the polymerization initiator.

The thermoplastic resin composition may contain, other than the polycarbonate (A), the graft copolymer (B), the styrene-acrylonitrile based copolymer (C), and the unsaturated dicarboxylic anhydride-based copolymer (D), other resin components, impact resistance modifiers, fluidity modifiers, hardness modifiers, antioxidants, inorganic fillers, delustering agents, flame retardants, auxiliary flame retardants, anti-dripping agents, slidability imparting agents, heat releasing agents, electromagnetic absorbers, plasticizers, lubricants, mold releasing agents, ultraviolet absorbers, light stabilizers, antibacterial agents, antifungal agents, antistatic agents, carbon black, titanium oxide, pigments, dyes, and the like without impairing the effects of the present invention.

The thermoplastic resin composition may be produced by a known method. An example of such a method includes melt blending the polycarbonate (A), the graft copolymer (B), the styrene-acrylonitrile based copolymer (C), and the unsaturated dicarboxylic anhydride-based copolymer (D) with a twin-screw extruder. The twin-screw extruder may be either co-rotating or counter rotating. Other examples of the melt blender include a single-screw extruder, a multi-screw extruder, a twin-rotor continuous kneader, a cokneader, and a Banbury mixer. For use of a twin-screw extruder, cylinder temperature settings may be selected ranging 200-320° C. and preferably 210-290° C.

The thermoplastic resin composition may be molded by a known method. Examples of the molding method include injection molding, sheet extrusion molding, vacuum molding, blow molding, foam molding, contour extrusion molding, and the like. During general molding, the thermoplastic resin composition is processed after being heated at 200-280° C., preferably 210-270° C. The articles thus molded are applicable to automobile parts, home appliances, business machine parts, and the like.

### EXAMPLES

Detailed descriptions are given below with reference to Examples. Note that the present invention is not limited to the following Examples.

For polycarbonate (A), the following materials were used.

(a-1) Iupilon S-3000 produced by Mitsubishi Engineering-Plastics Corp.
(a-2) WONDERLITE PC-110 produced by CHIMEI Corp.

The graft copolymer (B) was prepared by emulsion graft polymerization. A reactor with a stirrer was charged with 126 parts by mass of polybutadiene latex having an average particle size of 0.3 μm, 17 parts by mass of styrene-butadiene latex having an average particle size of 0.5 μm and a styrene content of 24 mass %, 1 part by mass of sodium stearate, 0.2 parts by mass of sodium formaldehyde sulfoxylate, 0.01 parts by mass of tetrasodium ethylenediaminetetraacetic acid, 0.005 parts by mass of ferrous sulfate, and 150 parts of pure water and heated at a temperature of 50° C. In addition, 45 parts by mass of a monomer mixture of 75 mass % of styrene and 25 mass % of acrylonitrile, 1.0 parts by mass of t-dodecyl mercaptan, and 0.15 parts by mass of cumene hydroperoxide were split added there continuously for 6 hours. After finishing split addition, the temperature was raised to 65° C. and polymerization was completed by taking 2 hours to produce latex of the graft copolymer (B). The latex thus produced was coagulated by two methods. In one method, coagulation was performed using magnesium sulfate and sulfuric acid as coagulants and having a slurry at pH for coagulation of 6.8, followed by washing and dewatering and then drying to obtain a powdered graft copolymer (b-1). In the other method, coagulation was performed using hydrochloric acid as a coagulant, followed by washing and dewatering and then drying to obtain a powdered graft copolymer (b-2). The amounts of metal elements in (b-1) and (b-2) were measured by atomic absorption, and the results were as follows:

(b-1) the amount of magnesium 660 ppm;
(b-2) the amount of magnesium less than the detection limit (<1 ppm).

The graft copolymers (b-1) and (b-2) are different only in the coagulation method and are same in the constituents of the graft copolymer, such as the styrene-acrylonitrile content, the polybutadiene content, the gel content, the graft ratio, the degree of swelling in toluene, and the volume average particle size. The polybutadiene content was 55 mass % based on the ratio of material combination in emulsion graft polymerization. The constituents other than the rubbery polymer were measured by NMR; styrene was 75 mass % and acrylonitrile was 25 mass %. The gel content was 83 mass % by centrifugal separation. The graft ratio was calculated from the gel content and the polybutadiene content to find 51%. The degree of swelling in toluene was 9.2, and the volume average particle size was calculated from TEM observation to find 0.3 μm.

The styrene-acrylonitrile based copolymer (C) was prepared by continuous bulk polymerization. Polymerization was performed using one complete mixing stirring chamber as a reactor with a volume of 20 L. A material solution of 60.5 mass % of styrene, 21.5 mass % of acrylonitrile, and 18.0 mass % of ethylbenzene was prepared to be continuously supplied to the reactor at a flow rate of 6.5 L/h. In addition, t-butylperoxyisopropyl monocarbonate as a polymerization initiator and n-dodecyl mercaptan as a chain transfer agent were continuously added at a concentration of, respectively, 160 ppm and 1500 ppm relative to the material solution to a supply line of the material solution. The reaction temperature in the reactor was regulated at 145° C. The polymer solution continuously taken from the reactor was supplied to a vacuum devolatilization chamber with a preheater to separate unreacted styrene, acrylonitrile, and ethylbenzene. The temperature in the preheater was regulated to make the polymer temperature in the devolatilization chamber at 225° C., and the pressure in the devolatilization chamber was 0.4 kPa. The polymer was extracted from the vacuum devolatilization chamber by a gear pump and extruded in a strand and cooled in cooling water, followed by cutting to obtain a pelletized styrene-acrylonitrile based copolymer (c-1). The acrylonitrile unit content in (c-1) was measured by the Kjeldahl method to find 25 mass %. The weight average molecular weight of (c-1) was 105,000. The weight average molecular weight was a polystyrene equivalent measured by gel permeation chromatography (GPC) and measured in the following conditions:

Apparatus SYSTEM-21 Shodex (manufactured by Showa Denko K.K.);

Column 3 pieces of PL gel MIXED-B in series

Temperature 40° C.

Detection Differential Refractive Index

Solvent Tetrahydrofuran

Concentration 2 mass %

Calibration Curve Prepared using polystyrene standard (PS) (produced by PL).

The unsaturated dicarboxylic anhydride-based copolymer (D) was prepared by solution polymerization. An autoclave with a stirrer as a reactor was charged with 60 parts by mass of styrene, 8 parts by mass of maleic anhydride, 0.2 parts by mass of an a methylstyrene dimer, and 25 parts by mass of methyl ethyl ketone. The system was purged with nitrogen gas, followed by raising the temperature to 92° C. and adding a solution for 7 hours where 32 parts by mass of maleic anhydride and 0.18 parts by mass of t-butylperoxy-2-ethylhexanoate were dissolved in 100 parts by mass of methyl ethyl ketone. After the addition, 0.03 parts by mass of t-butylperoxy-2-ethylhexanoate was further added and the temperature was raised to 120° C. for further reaction for 1 hour to obtain a polymer solution of a styrene-maleic anhydride copolymer. Then, 30 parts by mass of aniline and 0.6 parts by mass of triethylamine were added to the polymer solution for imidation reaction at 140° C. for 7 hours. The polymer solution after finishing the imidation reaction was supplied to a vented devolatilization extruder for removal of the volatile components to obtain a styrene-N-phenylmaleimide-maleic anhydride copolymer (d-1). The constituents of (d-1) were analyzed by NMR to find 48 mass % of a styrene unit content, 45 mass % of an N-phenylmaleimide unit content, and 7 mass % of a maleic anhydride unit content. The weight average molecular weight of (d-1) was 142,000. The weight average molecular weight of (d-1) was obtained by GPC in the same method as (c-1).

Similarly, a styrene-N-phenylmaleimide copolymer (d-2) containing no unsaturated dicarboxylic anhydride unit was prepared by solution polymerization. An autoclave with a stirrer as a reactor was charged with 48 parts by mass of styrene, 0.08 parts by mass of an a methylstyrene dimer, and 100 parts by mass of methyl ethyl ketone. The system was purged with nitrogen gas, followed by raising the temperature to 85° C. and adding a solution for 8 hours where 52 parts by mass of N-phenylmaleimide and 0.15 parts by mass of benzoyl peroxide were dissolved in 200 parts by mass of methyl ethyl ketone. After the addition, reaction was further performed at 85° C. for 3 hours to obtain a polymer solution of a styrene-N-phenylmaleimide copolymer. The polymer solution after finishing the reaction was supplied to a vented devolatilization extruder for removal of volatile components to produce styrene —N-phenylmaleimide (d-2). The constituents of (d-2) were analyzed by NMR to find 48 mass % of a styrene unit content and 52 mass % of an N-phenylmaleimide unit content. The weight average molecular weight of (d-2) was 150,000. The weight average molecular weight of (d-2) was obtained by GPC in the same method as (c-1).

According to the formula shown in Table 1, polycarbonate (A), the graft copolymer (B), the styrene-acrylonitrile based copolymer (C), and the unsaturated dicarboxylic anhydride-based copolymer (D) were dry blended, followed by melt extrusion using a twin-screw extruder to obtain pellets of thermoplastic resin compositions in Examples, Comparative Examples, and Reference Example. As the twin-screw extruder, KZW15TW-30MG-NH-700 manufactured by Technovel Corp. was used with a screw diameter D=15 mm and L/D=45. The extrusion conditions were a screw speed of 250 rpm, a cylinder temperature of 280° C., and a discharge amount of 400 g/h. Then, the thermoplastic resin composition pellets thus obtained were molded to prepare test pieces for evaluation. For the injection molding machine, advanced AU3E manufactured by Nissei Plastic Industrial Co., Ltd. was used. The molding conditions were a nozzle temperature of 280° C., a die temperature of 60° C., an injection speed of 100 mm/s, and a holding pressure of 70 MPa. The test pieces for evaluation were in a dumbbell shape in the size of 50 mm in full length, 2 mm in thickness, 12 mm in parallel area length, and 2 mm in parallel area width.

Using the thermoplastic resin composition pellets, the melt mass-flow rate (MFR) under a load of 280° C. and 5 kg was measured. The measurement was performed using a melt flow indexer F-F01 manufactured by Toyo Seiki Seisaku-sho, Ltd. as the measuring device and an orifice with a length of 8.000 mm±0.025 mm and an inner bore of 2.095 mm. The measurement results are shown in Table 1.

Izod impact strength was measured using the test pieces for evaluation. The measurement was performed using a testing machine of Digital Impact Tester manufactured by Toyo Seiki Seisaku-sho, Ltd. in the conditions of energy of 1 J and a loading velocity of 2.9m/min. The maximum measurable impact strength was 15 kJ/m2 and NB denotes that the test piece was not broken. The notch shape was the type A described in JIS K7110. The measurement results are shown in Table 1.

TABLE 1

| | | | | | | | | | | | | | | Reference |
|---|---|---|---|---|---|---|---|---|---|---|---|---|---|---|
| | | | | Example | | | | | Comparative Example | | | | | Example |
| | | | | 1 | 2 | 3 | 4 | 5 | 1 | 2 | 3 | 4 | 5 | 1 |
| Formula | (A) Component | a-1 | mass % | 50 | 50 | 50 | 50 | — | 50 | 50 | 50 | 50 | 50 | 50 |
| | | a-2 | mass % | — | — | — | — | 50 | — | — | — | — | — | — |
| | (B) Component | b-1 | mass % | 15 | 15 | 15 | 15 | 15 | 15 | 15 | 15 | 15 | — | — |
| | | b-2 | mass % | — | — | — | — | — | — | — | — | — | 15 | 15 |
| | (C) Component | c-1 | mass % | 25 | 30 | 20 | 15 | 25 | 35 | 34 | 5 | 25 | 25 | 35 |
| | (D) Component | d-1 | mass % | 10 | 5 | 15 | 20 | 10 | — | 1 | 30 | — | 10 | — |
| | | d-2 | mass % | — | — | — | — | — | — | — | — | 10 | — | — |

| | | | | | | | | | | | | | |
|---|---|---|---|---|---|---|---|---|---|---|---|---|---|
| Evaluation | MFR (280° C., 5 kg) | g/10 min | 70 | 103 | 52 | 42 | 78 | 304 | 285 | 20 | 251 | 83 | 134 |
| | Izod impact strength | kJ/m² | NB | 15 | 15 | 12 | NB | 3 | 5 | 4 | 4 | 7 | 7 |

Comparative Example 1 is an example using a graft copolymer containing magnesium sulfate in terms of 660 ppm of magnesium amount, where excessive hydrolysis of polycarbonate caused low impact resistance and an increase in MFR was found. Reference Example 1 and Comparative Example 5 are examples using a graft copolymer produced by coagulating latex only by hydrochloric acid not to contain inorganic salt derived from the coagulant, where the impact resistance is slightly higher than that in Comparative Example 1. Since being in low pH conditions due to the single use of hydrochloric acid, these examples had a problem of corrosion in the production process of the graft copolymer. In contrast, in Examples, 2-25 mass % of the unsaturated dicarboxylic anhydride-based copolymer (d-1) was blended, causing significant improvement in impact resistance. In Examples 1-3 and 5 containing 5-15 mass % of (d-1), the impact resistance was particularly high, and among them, Examples 1 and 5 containing 7.0-13 mass % of (d-1) was more particularly high in impact resistance.

In Comparative Example 2, the amount of (d-1) was too little, and the effect of inhibiting hydrolysis was not found. In Comparative Example 3, the amount of (d-1) was too much, and the impact resistance was low. Since (d-2) used in Comparative Example 4 contained no unsaturated carboxylic anhydride unit, no effect of inhibiting hydrolysis was found. In Comparative Example 5, the (B) component substantially containing no magnesium was used. The impact strength was thus not improved compared with Reference Example 1 even by adding (d-1).

### INDUSTRIAL APPLICABILITY

The resin composition of the present invention is excellent in hydrolysis resistance and impact resistance and thus is useful for automobile parts, home appliances, business machine parts, and the like. A graft copolymer containing inorganic salt derived from a coagulant, generally used as an ABS resin, is applicable and thus useful for industrial applications.

1. A thermoplastic resin composition comprising:
polycarbonate (A); a graft copolymer (B); a styrene-acrylonitrile based copolymer (C); and an unsaturated dicarboxylic anhydride-based copolymer (D), wherein:
the graft copolymer (B) is produced by graft copolymerization of a rubbery polymer at least with a styrene-based monomer and an acrylonitrile-based monomer and the graft copolymer (B) contains a metal element; and
based on 100 mass % of a total amount of (A) to (D), a content of (A) is 40 to 93 mass %, a content of (B) is 5 to 30 mass %, a content of (C) is 0 to 40 mass %, and a content of (D) is 2 to 25 mass %.

2. The composition according to claim 1, wherein the unsaturated dicarboxylic anhydride-based copolymer (D) has unsaturated dicarboxylic anhydride-based monomer units of 0.5 to 30 mass %.

3. A molded article, comprising the composition according to claim 1.
